(19) United States
(12) Patent Application Publication
(10) Pub. No.: US 2009/0074016 A1
(43) Pub. Date: Mar. 19, 2009

(54) Apparatus for Terahertz wave generation from water vapor

(76) Inventors: Orval Mamer, Senneville (CA); Alain Lesimple, Roxboro (CA); Keith H. Johnson, Cambridge, MA (US); Yunqing Chen, Troy, NY (US); Masashi Yamaguchi, Green Island, NY (US); X.-C. Zhang, Melrose, NY (US); Matthew Price-Gallagher, Westmount (CA)

Correspondence Address: CHOATE, HALL & STEWART LLP, TWO INTERNATIONAL PLACE, BOSTON, MA, 02110, US

(21) Appl. No.: 11/582,817

(22) Filed: Oct. 18, 2006

(51) Int. Cl. H01S 3/10

(52) U.S. Cl. 372/22

(57) ABSTRACT

Apparatus for Terahertz wave generation. An amplified laser generates a pulsed optical fundamental beam and a crystal passes the fundamental beam to generate a second harmonic beam of the fundamental beam. A lens focuses the mixed fundamental and second harmonic beams and a gas cell containing water vapor receives the focused beams and generates Terahertz waves.

### BACKGROUND OF THE INVENTION

This invention relates to apparatus for Terahertz wave generation and more particularly to such apparatus generating Terahertz waves from water including vapor of water and solutions.

Terahertz (THz) waves, T-rays, or submilimeter/far-infrared waves, refer to electromagnetic radiation in the frequency interval from 0.1 to 10 THz. They occupy a large portion of the electromagnetic spectrum between the mid-infrared and microwave bands. A 1 Terahertz wave has a period of 1 picosecond, a wavelength of 300 μm. In other units, a 1 THz wave is equivalent to 33 cm⁻¹, 4.1 meV and 47.6 K. In the past decades, especially since the advent of THz time-domain spectroscopy (THz-TDS) far-IR spectroscopy has found extensive applications in various fields including gas sensing, explosives detection and security screening, pharmaceuticals, biological and biomedical study, etc. Compared to relatively well-developed sensing and imaging in microwave, mid-infrared and optical bands, basic research, advanced technology developments and real-world applications in the THz band are still in their infancy. Recent advances in THz science and technology make it one of the more promising research areas in the 21^{st} century for sensing and imaging, as well as in other interdisciplinary fields [3-8]. Numbers in brackets refer to the references appended hereto, the contents of which are incorporated herein by reference. It is expected that Terahertz wave research will enable innovative imaging and sensing capabilities for application in material characterization, microelectronics, medical diagnosis, environmental control and chemical and biological identification [1, 2]. Recent research suggests that intense THz radiation can be used to destroy cancerous tissue, not just to image it [31].

In the time-domain THz spectroscopy community, photoconductive dipole antennas and electro-optic crystals are commonly used for emitting and detecting pulsed THz waves. In general, most THz generation schemes provide quite low powers, severely restricting certain applications such as THz nonlinear optics. THz wave generation in ambient air has attracted considerable attention recently [9-13]. The first reported THz wave generation was achieved in the early 1990's by focusing an intense (peak power 10¹² W) laser beam into air [9]. Through the mixing of an optical fundamental wave with its second harmonic (SH) wave, generation of intense THz wave pulses in air has been demonstrated. Optical power dependence measurements across the air breakdown threshold suggest that ionized air (plasma) plays an important role in generation of THz radiation. Recently, a THz field strength greater than 100 kV/cm has been reported by using a similar experimental arrangement with shorter optical pulses [13].

Developing a high-power THz emitter is thus very crucial for real-world applications, especially for standoff detection of threats (i.e., explosives or chemical/biological hazards) concealed in clothing or packages.

### SUMMARY OF THE INVENTION

In one aspect, the apparatus for Terahertz wave generation according to the invention includes a femtosecond (fs) amplified laser generating a pulsed optical fundamental beam and a crystal for passing the optical fundamental beam to generate a second harmonic beam of the fundamental beam. A lens focuses the mixed fundamental and second harmonic beams and a gas cell containing water receives the focused beams to produce Terahertz waves. An off-axis concave parabolic mirror may be used in place of a lens. Water may be in its various physical states such as gaseous, vapor, liquid and including water clusters. In a preferred embodiment, the optical fundamental beam has a central wavelength of approximately 800 nm. A suitable laser is a Ti:sapphire regenerative amplifier generating approximately 1 mJ 100 fs pulses at a 1 kHz repetition rate. A suitable crystal is a type-I beta barium borate (BBO) crystal.

In a preferred embodiment, the water vapor has a partial pressure in the range of 6.9-23.6 torr. The gas cell may include a quartz window for receiving the focused beams and a high density polyethylene window through which the Terahertz waves emerge. A suitable BBO crystal thickness is 100 μm and the quartz window is a 100 μm thick quartz plate. A preferred embodiment of the invention further includes a gas distribution system connected to the gas cell to control pressure of the water vapor in the cell. A suitable laser power is in the 600-650 mW range.

The instrument disclosed and claimed herein uses water vapor as a nonlinear medium under pulsed optical excitation to generate intense broadband Terahertz wave emissions. The instrument contains a water vapor cell and a femtosecond amplified laser. The focused optical beam in the water vapor cell generates THz radiation in the forward direction. The ratio of the measured THz radiation electric field to the partial pressure of the water vapor is the strongest among all of the gases and organic vapors that were tested. Without being limited to any theory, the strong T-ray emission of water vapor is attributed by the inventors to the unique THz-frequency vibronic properties of protonated water nanoclusters that are believed to be a significant constituent of water vapor.

In yet another embodiment, the optical beam is focused onto a high-pressure stream of gas including water eliminating much of the loss due to water absorption.

The novel emitter disclosed herein provides much stronger THz emission than ambient air and commonly used electro-optic crystals. It is expected that the novel THz emitter disclosed herein will provide commercial solutions to many contemporary problems. It could become a new-generation THz source for THz time-domain spectrometers in the future.

The THz emitter disclosed herein is also very inexpensive compared with electro-optic crystals and is easy to replace once it is damaged or used for a long time. The emitter provides extremely intense THz electric fields and can provide a sub-picosecond far-infrared pulse. The THZ emission is highly directional [32] and the THz wave is ultra-broadband, up to 7 THz.

### BRIEF DESCRIPTION OF THE DRAWINGS

FIG. 1 is a schematic illustration of the experimental setup of apparatus to generate Terahertz waves.

FIG. 2a is a schematic illustration of the technique disclosed herein for the generation of THz waves using water vapor as the emitter.

FIG. 2b is a schematic illustration showing the emitter cell connected to a gas handling and distribution system, including a valve and pump, that allows pure vapors to be input into the gas cell and to control pressure of the vapor in the gas cell.

FIG. 3a is graph of amplitude versus time showing plots of recorded temporal waveforms of THz field signal generated from water vapor at 23.6 torr and from ambient air (752 torr), by changing a time delay between the THz field and an optical probe beam.

FIG. 3b is a graph of amplitude versus frequency showing the spectrum corresponding to the temporal waveforms of FIG. 3a.

FIG. 3c is a graph of amplitude versus time for pure water.

FIG. 4 is a plot of THz amplitude versus temperature for water vapor and air.

FIG. 5 is a plot of THz field figure of merit (electric field over partial pressure) versus first photo-ionization energy from different gases and vapors.

FIG. 6 is a pictorial representation of a pentagonal dodecahedral (H₂O)₂₁H⁺ cluster. The vectors represent the directions and amplitudes of component atomic displacements for one of the “squashing” vibrational modes in the 1.5-6 THz (50-200 cm⁻¹) frequency range.

FIG. 7 is a diagram showing density-functional molecular-orbital energies of the (H₂O)₂₁H⁺ cluster.

FIG. 8 is a pictorial representation of S-, P-, D-, and F-like LUMO wavefunctions of the (H₂O)₂₁H⁺ cluster.

FIG. 9 is a computed vibrational spectrum of the (H₂O)₂₁H⁺ cluster.

FIG. 10 is a schematic illustration of another embodiment of the invention using a gas jet.

### DESCRIPTION OF THE PREFERRED EMBODIMENT

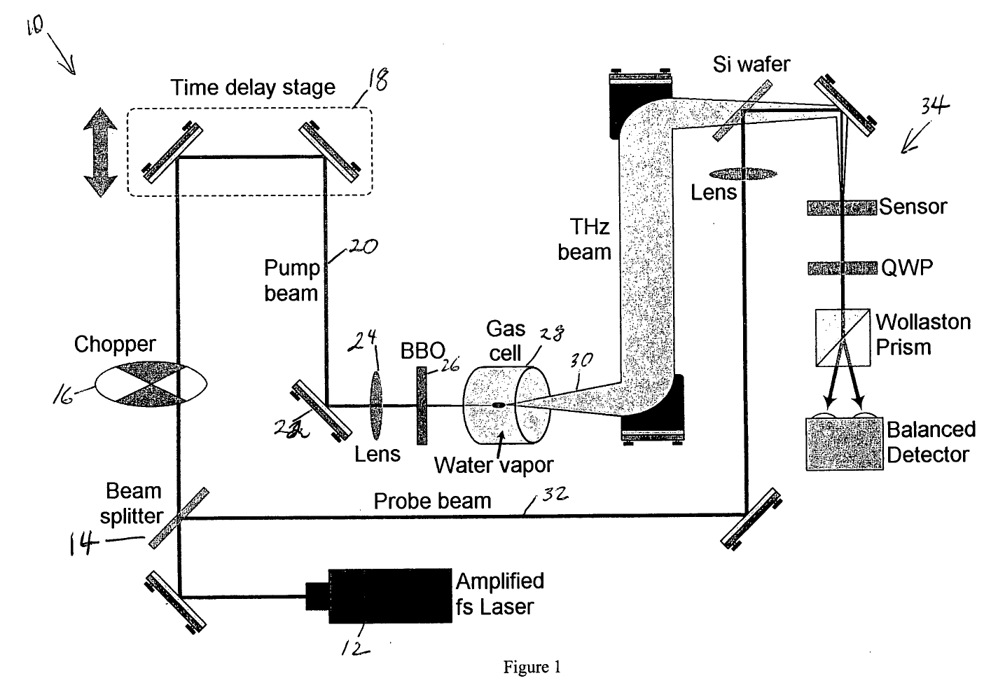

With reference first to FIG. 1, apparatus 10 for generating THz waves includes an amplified femtosecond laser 12. A suitable amplified femtosecond laser 12 is a desktop Ti:sapphire regenerative amplifier that generates approximately 1 mJ 100 fs pulses at a repetition rate of 1 kilohertz with a central wavelength at 800 nm. Suitable fundamental central wavelengths are in the range of 200-1000 nm. The experimental setup in FIG. 1 for four-wave-mixing assumes a 3^{rd}-order nonlinear optical process in water vapor. In this embodiment that includes THz wave generation and detection, the beam from the laser 12 is split into two beams by a 5%-95% broadband optical beam splitter 14. The stronger beam (95%) is used to generate the THz waves and the weaker beam (5%) is used to detect the THz waves. The stronger beam passes through a chopper 16 and time delay stage 18 and is referred to as pump beam 20. The pump beam 20 is redirected by a mirror 22 and is focused by a lens 24. The beam 20 then passes through a 100-μm thick type-I beta barium borate (BBO) crystal 26 and then into a gas cell 28. The gas cell 28 includes water vapor having a selected partial pressure. The intense optical excitation generates THz waves 30 that emanate from the gas cell 28. The weaker or probe beam 32 is used in a standard electro-optic sampling section 34 to detect the THz waves.

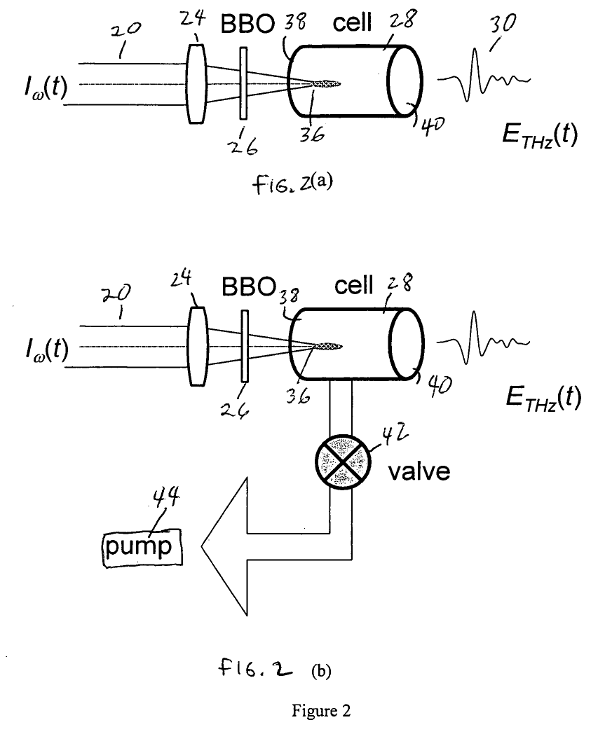

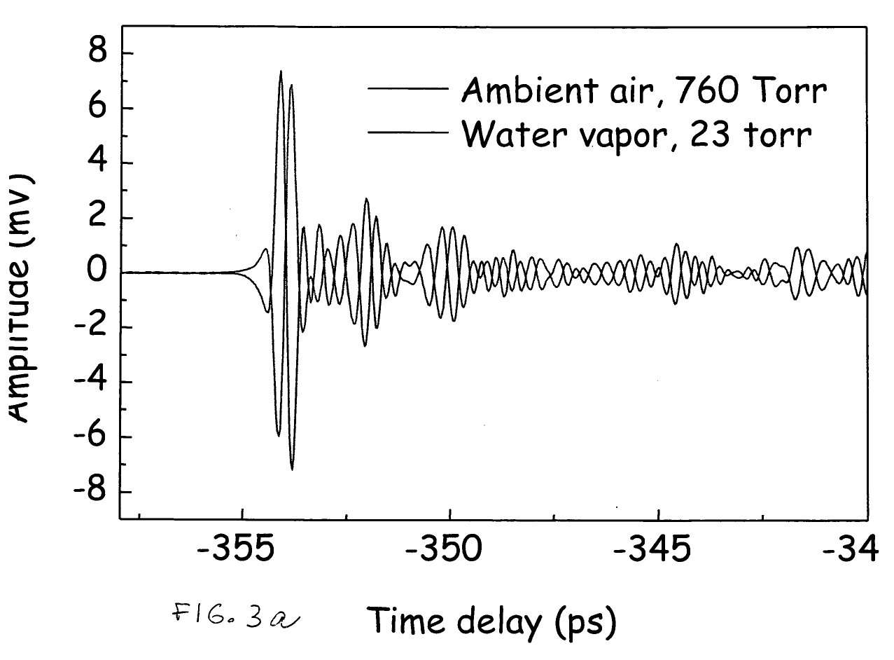

Terahertz wave generation will now be described in more detail with reference to FIGS. 2a and 2b. The pump beam 20, an optical fundamental beam (ω) along with its second harmonic beam (2ω) after passing through a 100 μm thick type-I beta barium borate (BBO) crystal 26, are focused on the gas cell 28 that contains water vapor therein. The water molecules and their clusters form a plasma under the intense optical excitation at the focal point 36. The free electron and positively charged water molecule or the photo-excited electron around the highly polarized molecule (a higher level Rydberg state) might contribute to the THz wave emission. A very intense, highly directional, ultra-broadband THz wave 30 is generated.

In this embodiment the gas cell 28 is a glass cell with a diameter of 30 mm and length 50 mm. A front window 38 through which the beam 20 passes is quartz. A rear window 40 from which the THz wave emanates is preferably high density polyethylene. As shown in FIG. 2b the gas cell 28 is connected to a gas handling system that includes a valve 42 and a pump 44 that allows a pure vapor to be input into the gas cell 28 and its pressure precisely controlled.

In the embodiment shown in FIGS. 1, 2a and 2b a suitable focal length for the lens 24 is 100 mm and a suitable distance between the BBO crystal 26 and the focal point 36 is 20 mm. A suitable pump beam 20 power is in the range of 600-650 mW and suitable probe beam 32 power of 20-50 mW. As mentioned above, a suitable pulse duration of the amplified laser is approximately 100 fs producing a beam having a central wavelength of 800 nm. A suitable time constant of a lock-in amplifier is in the range of 100-300 ms.

Referring again to FIG. 2a the optical input window 38 is a 3 mm thick, 30 mm diameter quartz plate. To avoid dispersion between the 800 nm and 400 nm beams on a 3 mm-thick quartz window, a 5 mm diameter hole is provided in the quartz window 38 and the hole is sealed with a 100 μm thick quartz plate.

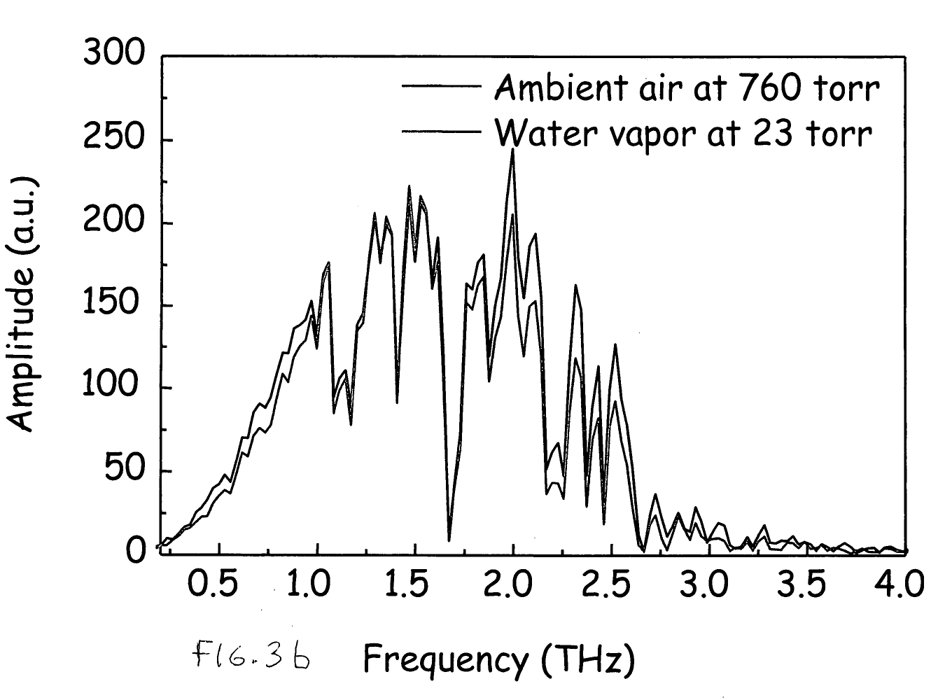

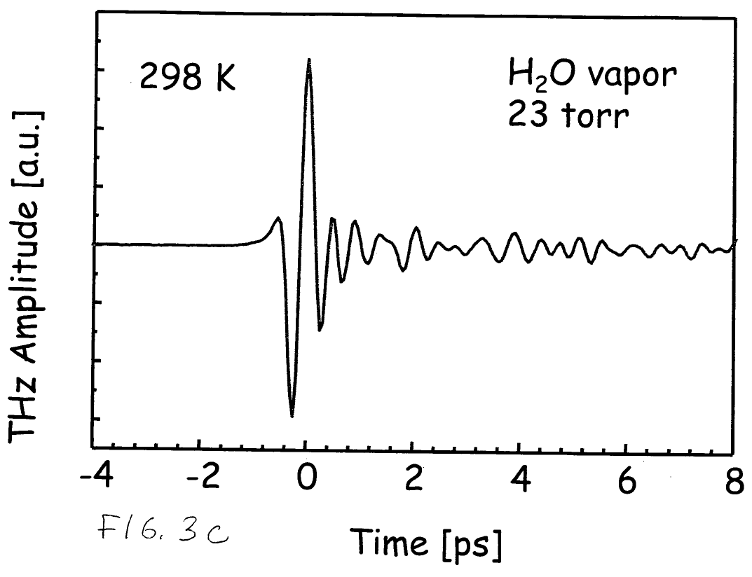

The detection of the Terahertz wave is standard electro-optic sampling methodology utilizing a 2.5-mm thick ZnTe crystal. FIG. 3a plots the recorded temporal waveforms of THz field signal from water vapor (23.6 torr) and from ambient air (752 torr) by changing the time delay between the THz field and the optical probe beam in the time delay stage 18. FIG. 3b shows the corresponding spectrum. FIG. 3c is similar to FIG. 3a but showing the THz waveform from pure water vapor alone.

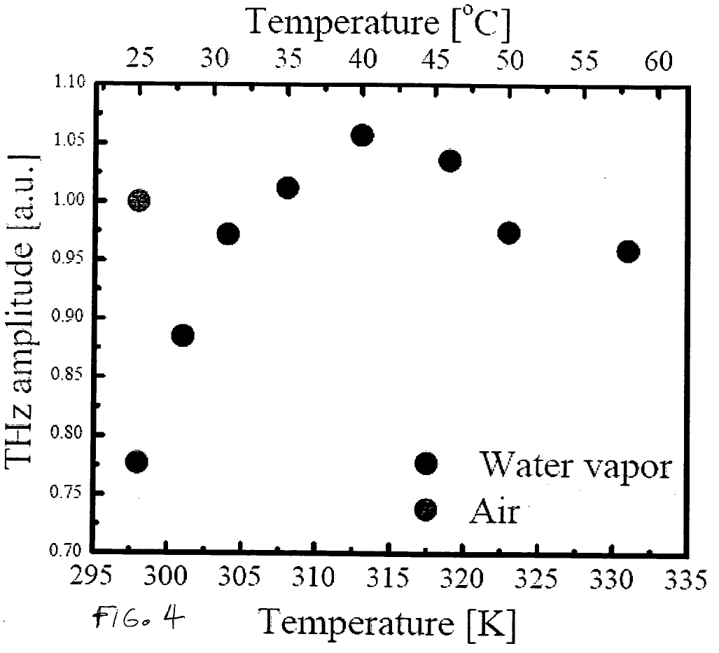

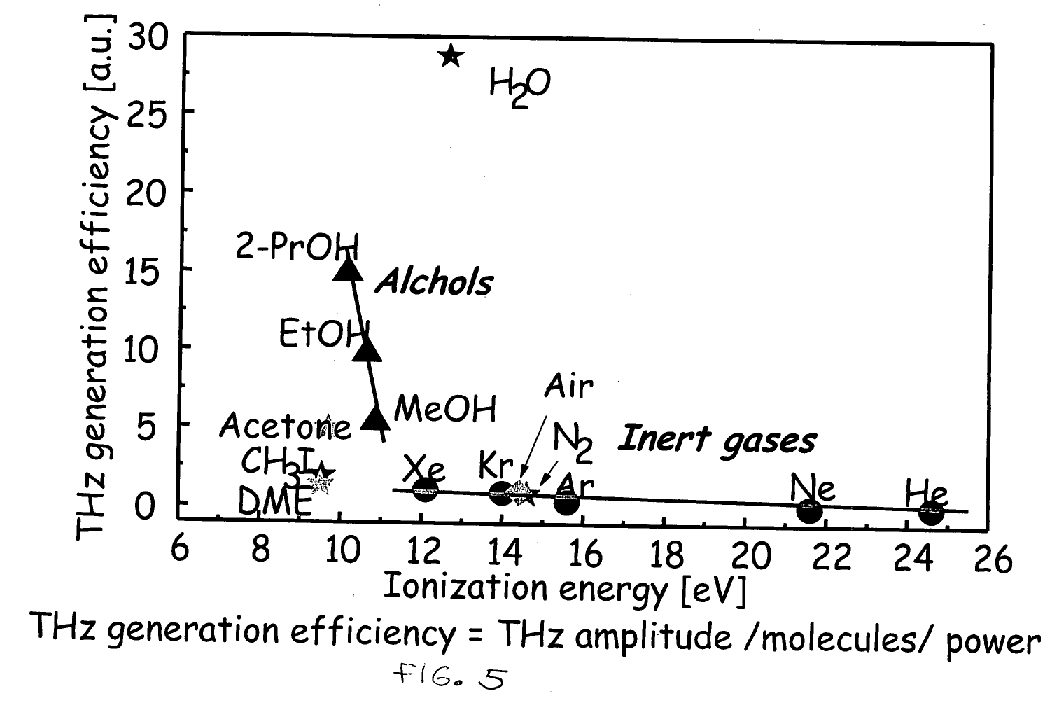

The emitted THz field amplitude is proportional to the pulse energy of the ω beam and the square root of the pulse energy of the 2ω beam, once the total optical pulse energy is above the plasma formation threshold. The optimal efficiency of the THz field is achieved when all the waves (ω, 2ω, and THz waves) share the same polarization. We tested several pressures at 6.9, 9.1, 11.9 and 23 torr, respectively. Within this pressure range (6.9 torr to 23.6 torr), the emitted THz field increases with the water vapor pressure. It should be noted that water vapor also has strong absorption for THz waves. If the distance between the optical focal spot and the exit window in the vapor cell increases, less THz radiation is expected. Current measurements with water vapor was performed at room temperature. Higher temperature leads to higher water vapor pressure. Upon heating, higher pressures should generate more intense THz radiation. FIG. 4 shows THz amplitude/temperature dependence for water vapor and air.

The four-wave-mixing (FWM) in the water vapor plasma is the major mechanism of THz wave generation. We also prove that the optimal efficiency of the THz field is achieved when all the waves (ω, 2ω, and THz waves) are at the same polarization corresponding to χ⁽³⁾ₓₓₓₓ in the FWM process, while the contribution from χ⁽³⁾_{xxyy} is very small.

In the FWM THz rectification process, the frequencies of the three input beams add to nearly zero (THz frequency). When a pulsed laser is used, the nonlinear response is driven by the envelope of the input fields. This envelope composes the rectified field which is the source of the THz wave. Mathematically, this third-order nonlinear process is related with χ⁽³⁾(Ω: 2ω+Ω, −ω, −ω), where Ω is the frequency of emitted THz wave. Predicted by the four-wave-mixing theory, the THz field at Ω has the form as,

E_{THz}(t)∝χ⁽³⁾E_{2ω}(t)E_{ω}*(t)E_{ω}*(t)cos(φ) (1)

Where E_{2ω}(t)=½E₄₀₀ exp(i2ωt)+c.c., E_{ω}(t)=½E₈₀₀ exp(iωt)+c.c. and the phase factor φ=k_{2ω}Δl is the relative phase difference between the ω and 2ω beams, with k_{2ω} being the wave vector of the 2ω beam and Δl being the path difference between the ω and 2ω beams along the beam propagation direction. Equation (1) is based on the plane-wave approximation. When describing the THz field as a function of optical beam power, Equation (1) can also be written as

E_{THz}∝χ⁽³⁾\sqrt{I_{2ω}}I_{ω} cos(φ) (2)

If the nonlinear media is spatially isotropic, there are three independent components in the third order susceptibility tensor: χ⁽³⁾ₓₓₓₓ, χ⁽³⁾_{xyxy} and χ⁽³⁾_{xxyy}, with the four subscripts corresponding to polarizations of Ω, 2ω, ω, ω beams, respectively.

As an example of the generation of intense THz wave radiation, we select ambient air as the nonlinear medium reference which has been extensively studied recently in our group. Our experimental results confirm that the threshold of THz wave generation is related to the air ionization threshold. We observed a turning point around 150 μJ (combined pulse energy of ω and 2ω beams). This is explained by the four-wave-mixing process in the plasma when the laser pulse energy exceeds the air ionization threshold. By considering the combination of different wavelength laser beams, we estimated the power density of 1.5×10¹⁴ W/cm² assuming the focal spot with 30 μm in diameter. Meanwhile, using the standard value of air χ⁽³⁾ with the 1.5×10¹⁴ W/cm² laser power intensity [15], the calculated THz field is about four orders smaller than our measured field. This behavior reveals the laser induced plasma with a greatly enhanced χ⁽³⁾ is the nonlinear media in which the THz wave is generated.

Table 1 lists the gases studied, their chemical symbols, 1^{st} photo-ionization energy, vapor pressures measured and their saturated pressure at 298 K, relative THz field to the ambient air, and the Field Figure of Merit. Ambient air emits about twice the THz field as water vapor, but its pressure is 764 torr, while in comparison, the vapor pressure of water is only 23 torr. Here, we introduce a Field Figure of Merit (FOM) as the THz Field/Partial Pressure. The Field Figure of Merit from the water vapor is 18.5 times stronger than the air, and it is the strongest one among all measured THz field from gases and vapors, as shown listed in Table 1. The number of molecules in a fixed volume is linearly proportional to the partial pressure. When the Figure of Merit is defined as the THz Power/Partial Pressure, then the Power FOM from the water vapor is a factor of 380 stronger than that from ambient air!

TABLE 1
The name of the gases, their chemical symbols, 1^{st} photo-ionization energy,
vapor pressures measured and their saturated pressure at temperature 298 K, relative THz
field to the ambient air, and the Field Figure of Merit. The measured THz wave field/
molecule from the water vapor, normalized with the optical power, is the highest one among
all the gaseous we measured.
THz Wave Generation Efficiency in various Gases

| | | | Vapor pressure (Torr) | | THz generation efficiency: |
|---|---|---|---|---|---|
| | | 1^{st} Ionization energy | measured condition and Saturated vapor | Relative THz | (THz amplitude/molecules/pump |
| Name | Chemical structure | (eV) | pressure at 298 K (in a bracket) | amplitude | power) relative to air |
| Water | H₂O | 12.58 | 23.0 (23.7) | 0.87* | 28.83 |
| (pure vapor) | | | | | |
| Acetone | CH₃COCH₃ | 9.69 | 147 (229.52) | 0.95 | 4.91 |
| Methanol | CH₃OH | 10.85 | (127.1) | 0.89 | 5.34 |
| Ethanol | CH₃CH₂OH | 10.62 | (59.0) | 0.76 | 9.77 |
| 2-Propanol | CH₃CH₂OHCH₃ | 10.12 | (42.7) | 0.84 | 14.93 |
| Diethylether | CH₃CH₂OCH₂CH₃ | 9.51 | 496 (501.9) | 0.87 | 1.34 |
| Iodomethane | CH₃I | 9.54 | 192.2 (400) | 0.48 | 1.91 |
| Nitrogen | N₂ | 14.6 | 748.8 (N/A) | 0.83 | 0.84 |
| Xenon | Xe | 12.1 | 700 (N/A) | 2.24 | 2.43 |
| Krypton | Kr | 14.0 | 553.1 (N/A) | 1.49 | 2.05 |
| Argon | Ar | 15.6 | 756.6 (N/A) | 0.84 | 0.84 |
| Neon | Ne | 21.6 | 803.1 (N/A) | 0.20 | 0.18 |
| Helium | He | 12.6 | 762 (N/A) | 0.14 | 0.14 |
| Air | N₂ + O₂ + α | 14.6 (N₂) | 764 (N/A) | 1.00 | 1.00 |
| | | 13.6 (O₂) | | | |
| ZnTe | ZnTe | N/A | N/A (N/A) | 0.40 | N/A |
| (thickness 1 mm) | | | | | |

*Original data shows 88% of amplitude compared to air at 752 Torr. This value was scaled to 87% relative to amplitude from air at 764 Torr assuming linear change in pressure.

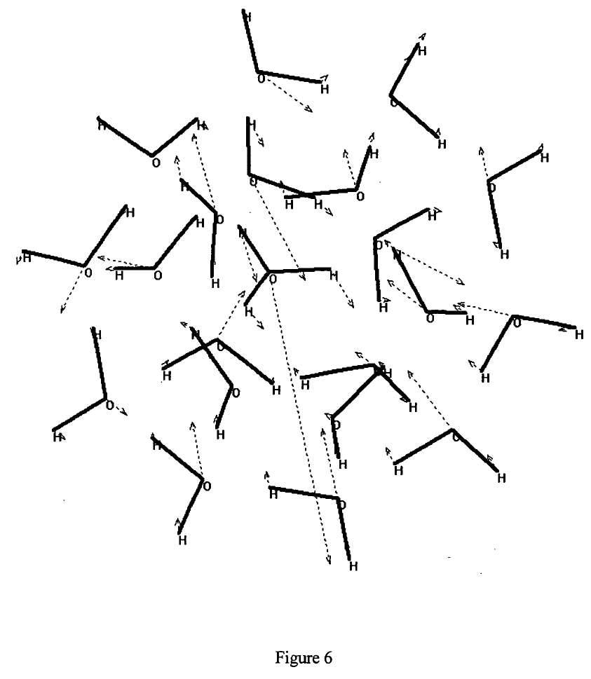

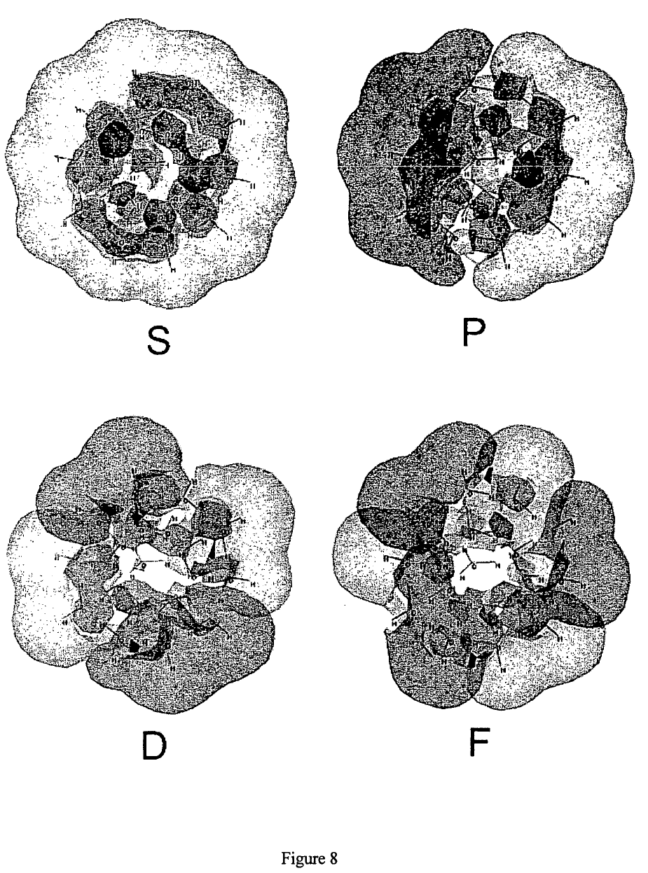

FIG. 5 plots the THz field Figure of Merit versus 1^{st} ionization energy. Only inert gases follow the expected rule that lower ionization energy yields stronger THz radiation. If we believe water vapor consists only of single water molecules, these monomers do not have the lowest ionization energy, yet water vapor shows the strongest THz radiation. The presence of a significant quantity of clusters of water molecules, which have significantly lower first ionization energy (tracking the HOMO energy level in FIG. 8) than single water molecules in the vapor, can explain this extraordinarily high THz emission from water vapor:

Strong Terahertz Emission from Water Clusters

We expected that the four-wave-mixing rectification in the laser-induced water vapor plasma is the main mechanism of the THz wave generation in the air plasma through the use of individual control of the ω and 2ω beams. However the presence of water clusters could be the major reason for the strongest radiation when a 400 nm optical beam is introduced with the excitation of 800 nm beam (second harmonic wave of the fundamental wave), as discussed below:

Recent scientific interest in water clusters has been motivated by their possible roles in atmospheric and environmental phenomena [16,17], biology [18], and astrophysics [19], as well as by their relevance to the structure and properties of liquid water and ice [20]. Experiment and theory agree that not only can such clusters be produced, but also they exist optimally in certain “magic numbers” and configurations of water molecules [21-28]. Prominent among the magic-number water clusters are ones possessing an approximately pentagonal dodecahedral structure. Ideally, these clusters have a closed, icosahedral symmetry formed by 20 hydrogen-bonded water molecules, with their oxygen atoms at the vertices of 12 concatenated pentagons and with 10 free exterior hydrogen atoms. FIG. 6 shows the protonated water cluster, (H₂O)₂₁H⁺, which occurs as a dominant molecular species in a variety of experiments [21-25]. Its clathrate structure—a hydronium ion, H₃O⁺, or neutral water molecule plus proton H⁺ trapped in the dodecahedral cage [25]—is the ideal protonated water cluster prototype for theoretical investigation.

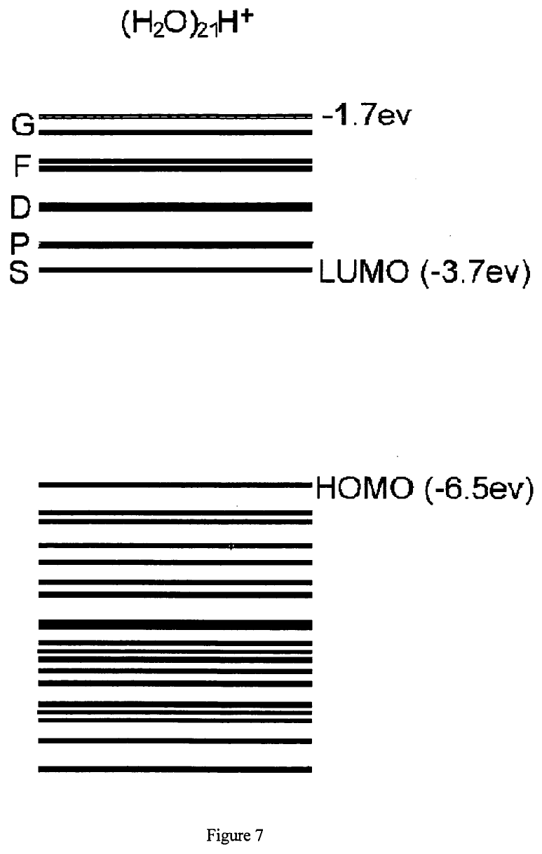

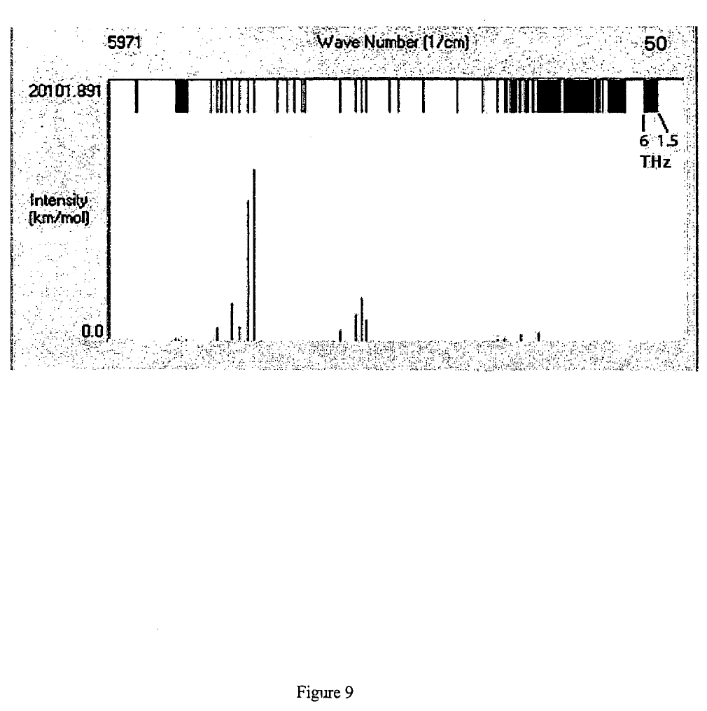

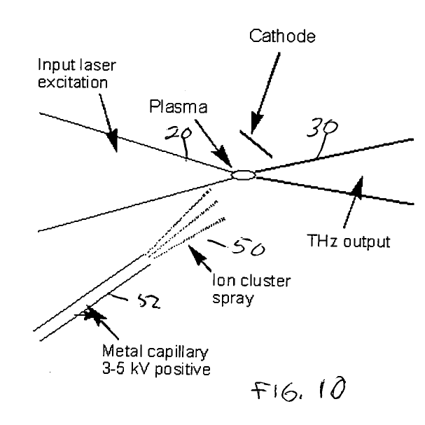

Ab initio density-functional molecular-orbital levels for the archetype (H₂O)₂₁H⁺ cluster of FIG. 6 are shown in FIG. 7. The lowest unoccupied (LUMO) energy levels correspond to the huge, delocalized “S”-, “P”-, “D”- and “F”-like cluster wavefunctions mapped in FIG. 8. The S-like LUMO level is separated from the highest occupied (HOMO) level by an energy gap of nearly 3 eV. The vibrational modes of the (H₂O)₂₁H⁺ cluster have also been computed, producing the complete spectrum shown in FIG. 9. Of particular interest is the lowest frequency manifold of cluster modes between 1.5 and 6 THz (50 to 200 cm⁻¹). The vectors in FIG. 6 show a typical “squashing:” mode of the dodecahedral cluster, with a large-amplitude vibration of the clathrated hydronium oxygen atom coupled to breathing vibrations of the cluster “surface” oxygen atoms. O—H “stretching” and “bending” vibrational modes are shown in FIG. 9 to occur at much higher frequencies spanning the broad infrared region of the spectrum. The most intense modes are localized high-infrared-frequency O—H bond stretches. The 1.5-6 THz (50 to 200 cm⁻¹) manifold is uniquely due to water molecule clustering and is relatively less intense because of the collective mode delocalization. Density-functional calculations for larger water clusters show similar manifolds of terahertz modes.

Anomalous emission and absorption of submillimeter (THz) radiation from the atmosphere were first identified by Gebbie [29] as possibly associated with aerosols of water clusters undergoing solar optical pumping. He argued that at sea-level densities such aerosols are separated by 10⁴ times their cluster radii and, under this condition of isolation, can be pumped by photons into vibrational modes of lowest frequency analogous to a Bose-Einstein condensation, thus acquiring giant electric dipoles. Their interaction with radiation is thereby greatly enhanced. For example, atmospheric aerosol absorption at 50 cm⁻¹ is comparable with that of a water molecule rotation line at 47 cm⁻¹, which has a transition dipole of 1.1 Debyes in an air sample containing 10¹⁷ cm⁻³ water molecules. Even if the aerosol density of water clusters is only approximately 10⁴ cm⁻³ [16, 30], then an effective aerosol transition moment of 10⁶ Debyes can be inferred. In other words, Gebbie [29] attributed this greatly enhanced submillimeter (THz) absorption and emission from comparatively low-density aerosols to solar optical pumping, cooperative stimulated emission, and maser action of the constituent water clusters.

The electronic structure (FIG. 7) and vibrational spectrum (FIG. 9) of the (H₂O)₂₁H⁺ cluster satisfy the conditions suggested by Gebbie [29]. First, the near-ultraviolet optical pumping of an electron from the HOMO to LUMO (such as produced by our 400 nm laser) puts the electron into the bound S-like cluster molecular orbital mapped in FIG. 8. This is a stable excited state of the cluster. Near-infrared absorption (such as produced by our 800 nm laser) can then excite the LUMO S-like electron to the nearby unoccupied P-like orbital (FIGS. 7 and 8). Actually, there are three nearly degenerate P-like cluster molecular orbitals, analogous to the degenerate pₓ, p_{y}, and p_{z} orbitals of an atom. Unlike an atom, however, the Pₓ, P_{y}, P_{z} near-degeneracy in the water cluster subjects it to the dynamic Jahn-Teller (DJT) effect, where the cluster attempts to remove the degeneracy and lower its energy through vibronic coupling and symmetry breaking. Near-infrared promotion (produced by our 800 nm laser) of the optically pumped electron between the closely spaced P-like and D-like cluster energy levels (FIG. 7) is also likely. Even in the absence of DJT coupling, excitations within the LUMO manifold can decay vibronically due to the mixing of electronic states. The vibrations here are the THz modes that are the lowest-frequency (H₂O)₂₁H⁺ cluster modes, like the “squashing mode” shown in FIG. 6. The predicted electric dipole moment of the (H₂O)₂₁H⁺ cluster in its optically pumped state is nearly 10 Debyes, as compared with the 1.1 Debye moment for a single water molecule. As shown by the vectors in FIG. 6, the large-amplitude THz vibration of the clathrated hydronium oxygen atom, coupled to breathing modes of the cluster “surface” oxygen atoms, produces an oscillating large electric dipole moment that constitutes the transition moment for T-ray emission and absorption when the cluster is optically pumped. The excited electron in the LUMO manifold is weakly bound compared to the cluster hydrogen-bonded “valence” electrons below the LUMO level. In fact, the occupied cluster molecular orbital levels below the HOMO (FIG. 7) are analogous to the “valence band” of a semiconductor, whereas the LUMO manifold is analogous to a semiconductor “conduction band”. Thus in an aerosol of (H₂O)₂₁H⁺ clusters, the ensemble of optically pumped electrons in the LUMO manifolds, loosely bound to the vibrationally activated, positively charged (H₂O)₂₁H⁺ molecular ion “cores”, effectively constitutes a “plasma”. An alternative scenario is to view an electron in the LUMO manifold “conduction band”, responsible for the large dipole moment of the clusters, as oscillating in the reference frame of the (H₂O)₂₁H⁺ ion core. Since the positive charge of the (H₂O)₂₁H⁺ cluster is due to the “extra” proton, an even simpler picture is a “hydrogenic plasma” model, in which the aerosol is modeled as electrons loosely bound to protons in large-radius “Rydberg-like” S-, P-, D- or F-like orbits.

As originally suggested by Carlon [16] and Gebbie [29], it is reasonable to expect that ambient air of modest humidity should contain aerosols comprised of water clusters such as (H₂O)₂₁H⁺. Thus, the above water cluster theory may explain the origin of intense T-ray emission from water vapor when combined near-ultraviolet (400 nm) and near-infrared (800 nm) laser beams are applied in the above-described invention.

Finally, it is worth pointing out that if we switch the order of the THz field and the second harmonic field in the third order susceptibility in the four-wave-mixing optical process, it should be possible to measure the THz wave by using water vapor as a nonlinear sensor. The reciprocal nature of such nonlinear optical process with the resonance nature in water vapor (molecules and their clusters) should provide unprecedented instrumental performance and innovation when we use water vapor as the THz wave emitting source and THz wave detecting medium.

To estimate the THz emission power of water clusters in apparatus disclosed herein, we begin with the standard formula for electromagnetic radiation power emission from an oscillating electric dipole (in cgs units):

P=p²ω⁴/3c³

where p is the dipole moment, ω is the (angular) frequency of the dipole vibration—in a protonated water cluster (FIG. 6) the “squashing vibration shown in the attached FIG. 6—and c is the velocity of light. The dipole moment of the protonated cluster (H2O)₂₁H⁺ in its ground state is approximately 10 Debyes (1 Debye=10⁻¹⁸ esu-cm). Under 400 nm electron excitation across the HOMO-LUMO energy gap of this cluster (FIG. 7) as well as the similar gaps of larger water clusters, including neutral ones, p can approach 50 D, i.e. the effective dipole moment of an optically pumped water cluster is much larger than that of the ground state. Therefore at THz frequencies, e.g. 1.5 THz, the emission power output of a single water cluster is typically of the order of (converting cgs to MKS units) 10⁻²¹ watt/cluster. For a room-temperature density of 10¹² neutral water clusters/cm³ (according to Carlon), this yields a potential THz emission power of approximately 10⁻⁹ watt or a nanowatt/cm³. Therefore a one cubic meter water-vapor chamber containing such a density of water clusters should potentially produce a milliwatt of THz radiation, i.e. comparable to that produced by a GaAs semiconductor source. Raising the temperature of the chamber should significantly increase the water cluster population, approaching 10¹⁵/cm³ at 100 degC (according to Carlon). This would imply 10⁻⁶ watt/cm³ or a microwatt/cm³—or one watt/m³, which is approaching/exceeding the highest conventional THz power density currently available.

Another embodiment of the invention is shown in FIG. 10. Instead of the gas cell 28 shown in FIG. 1, an ion cluster spray or jet 50 from a capillary tube 52 is introduced into the beam 20 resulting in the emission of Terahertz waves 30. By focusing the optical beam 20 onto a high-pressure stream of gas, one can avoid the dispersion introduced by the window 38 on the gas cell 28, as well as greatly reduce the amount of gas that the THz wave passes through thereby eliminating much of the loss due to water absorption. In terms of a quantitative approach, this method may allow for higher overall efficiency as well as a more precise study of the behavior at temperatures and pressures difficult to reach with the cell method disclosed above. The use of the cell in the earlier embodiment makes it easy to know the temperature and pressure, but can result in dispersion and absorption. The use of the jet, however, makes it more difficult to know the density. The capillary sprayer 52 may be arranged at an angle to the beam 20 as shown in FIG. 10 or it may be advantageous to arrange the sprayer 52 to be perpendicular to the beam 20.

It is recognized that modifications and variations of the invention described herein will occur to those of ordinary skill in the art and it is intended that all such modifications and variations be included within the scope of the appended claims.

### REFERENCES

1. Ferguson, B., Zhang, X.-C. Materials for terahertz science and technology. Nature Materials 1, 26-33 (2002).
2. Zandonella, C. Terahertz imaging: T-ray specs. Nature 424, 721-722 (2003).
3. Cole, B. E., Williams, J. B., King, B. T., Sherwin, M. S., Stanley, C. R. Coherent manipulation of semiconductor quantum bits with terahertz radiation. Nature 410, 60-63 (2001).
4. Huber, R., Tauser, F., Brodschelm, A., Bichler, M., Abstreiter, G., Leitenstorfer, A. How many particle interactions develop after ultrafast excitation of an electron-hole plasma. Nature 414, 286-289 (2001).
5. Carr, G. L. et al. High-power terahertz radiation from relativistic electrons. Nature 420, 153-156 (2002).
6. Köhler, R. et al. Terahertz semiconductor-heterostructure laser. Nature 417, 156-159 (2002).
7. Kaindl, R. A., Carnahan, M. A., Hagele, D., Lovenich, R., ChemIa, D. S. Ultrafast terahertz probes of transient conducting and insulating phases in an electron-hole gas. Nature 423, 734-738 (2003).
8. Wang, K., Mittleman, D. M. Metal wires for terahertz wave guiding. Nature 432, 376-379 (2004).
9. Hamster, H., Sullivan, A., Gordon, S., White, W., Falcone, R. W. Subpicosecond, electromagnetic pulse from intense laser-plasma interaction. Phys. Rev. Lett., 71, 2725-2728 (1993).
10. Tzortzakis, S., Mechain, G., Patalano, G., André, Y.-B., Prade, B., Franco, M., Mysyrowicz, A., Munier, J.-M., Gheudin, M., Beaudin, G., & Encrenaz, P. Coherent subterahertz radiation from femtosecond infrared filaments in air. Opt. Lett. 27, 1944-1946 (2002).
11. Cook, D. J., Hochstrasser, R. M. Intense terahertz pulses by four-wave rectification in air. Opt. Lett., 25, 1210-1212 (2000).
12. Kress, M., Loffler, T., Eden, S., Thomson, M., & Roskos, H. G. Terahertz-pulse generation by photoionization of air with laser pulses composed of both fumdamental and second-harmonic waves. Opt. Lett. 29, 1120-1122 (2004).
13. Bartel, T., Gaal, P., Reimann, K., Woemer, M., & Elsaesser, T. Generation of single-cycle THz transients with high electric-field amplitudes. Opt. Lett. 30, 2805-2087 (2005).
14. Wu, Q., & Zhang, X.-C. Free-space electro-optic sampling of terahertz beams. Appl. Phys. Lett. 67, 3523-3525 (1995).
15. Xie, X., Dai J. M., and Zhang, X.-C., “Coherent control of THz wave generation in ambient air,” Phys. Rev. Letts., 96 075005 (2006).
16. H. Carlon, J. Appl. Phys. 52, 3111 (1981).
17. R. G. Keesee, J. Geophys. Res. 94, 14683 (1989),
18. M. M. Teeter, Proc. Natl. Acad. Sci. 81, 6014 (1984);
19. W. W. Duley, Astrophys. J. Lett. 471, L57 (1996).
20. F. N. Keutsch and R. J. Sakally, Proc. Natl. Acad. Sci. 98, 10533 (2001).
21. H. Haberland, in Electronic and Atomic Collisions, J. Eichler et al., Eds. (Elsevier, N.Y., 1984), p. 597
22. V. Hermann et al., Chem Phys. 76, 2031 (1982).
23. U. Nagashima et. al., J. Chem. Phys. 84, 209 (1986).
24. X. Yang and A. W. Castleman, Jr., J. Am. Chem. Soc. 11, 6845 (1989).
25. M. Miyazaki et al., Science 304, 1135 (2004); J.-W. Shin et al., Science 304, 1140 (2004)
26. P. M. Holland and A. W. Castleman, Jr., J. Chem. Phys. 72, 5984 (1980).
27. R. E. Kozack and P. C. Jordan, J. Chem. Phys. 99, 2978 (1993).
28. J.-L. Kuo and M. L. Klein, J. Chem. Phys. 122, 024516 (2005).
29. H. A. Gebbie, Nature 296, 422 (1982); Science Progress 78 (2), 147 (1995).
30. H. Pruppacher and J. D. Klett, Microphysics of Clouds and Precipitation (Reidel, Dordrecht, 1978).
31. J. Nishizawa and J. Shibata, published application JP2005224580A2.
32. H. Zhong, N. Karpowicz and X.-C. Zhang, “Terahertz emission profile from laser-induced air plasma”, Applied Physics Letters 88, 261103 (2006).

1. Apparatus for Terahertz wave generation comprising:
an optical source generating an optical fundamental beam;
means for generating a second harmonic beam of the fundamental beam mixed with the fundamental beam;
an optical device for focusing the mixed fundamental and second harmonic beams; and
a cell containing water for receiving the focused beams to produce Terahertz waves.

2. The apparatus of claim 1 wherein the optical source is a laser.

3. The apparatus of claim 2 wherein the laser is an amplified laser.

4. The apparatus of claim 3 wherein the amplified laser generates a pulsed beam.

5. The apparatus claim 1 wherein the means for generating the second harmonic beam is a crystal.

6. The apparatus of claim 5 wherein the crystal is type-I beta barium borate (BBO).

7. The apparatus of claim 1 wherein the optical device is a lens.

8. The apparatus of claim 1 wherein the optical device is an off-axis parabolic mirror.

9. The apparatus of claim 1 wherein the water is in various physical states.

10. The apparatus of claim 1 wherein the water is in the gaseous state.

11. The apparatus of claim 1 wherein the water is in the vapor state.

12. The apparatus of claim 1 wherein the water includes water clusters.

13. The apparatus of claim 12 wherein the water clusters are charged or uncharged.

14. The apparatus of claim 1 wherein the fundamental beam has a central wavelength in the range of 200 mm-1,000 nm.

15. The apparatus of claim 14 wherein the fundamental beam has a central wavelength of approximately 800 nm.

16. The apparatus of claim 2 wherein the laser is a Ti:sapphire regenerative amplifier generating approximately 1 mJ 100 fs pulses at a 1 kHz repetition rate.

17. The apparatus of claim 11 wherein the water vapor partial pressure is 20 torr or above.

18. The apparatus of claim 1 wherein the cell includes a quartz window for receiving the focused beams and a high density polyethylene window through which the Terahertz waves emerge.

19. The apparatus of claim 6 wherein the BBO crystal is approximately 100 μm thick.

20. The apparatus of claim 18 wherein the quartz window is an approximately 100 μm thick quartz plate.

21. The apparatus of claim 11 further including a gas distribution system connected to the gas cell to control pressure of the water vapor in the cell.

22. The apparatus of claim 7 wherein the lens has a 100 mm focal length.

23. The apparatus of claim 2 wherein the laser power in the range of 600-650 mW.

24. The apparatus of claim 4 wherein the laser generates a sub-picosecond far-infrared pulse.

25. Apparatus for Terahertz wave generation comprising:
an amplified laser generating a pulsed optical fundamental beam;
a crystal for passing the optical fundamental beam to generate a second harmonic beam of the fundamental beam;
a lens for focusing the mixed fundamental and second harmonic beam; and
a gas cell containing water vapor for receiving the focused beams to produce Terahertz waves.

26. The apparatus of claims 1 or 25 including the use of water vapor as a THZ sensor.

27. Apparatus for Terahertz wave generation comprising:
an optical source generating an optical fundamental beam;
means for generating a second harmonic beam of the fundamental beam mixed with the fundamental beam;
an optical device for focusing the mixed fundamental and second harmonic beam; and
structure generating a jet of water into the focused beams to produce Terahertz waves.
